(19) United States
(12) Patent Application Publication
(10) Pub. No.: US 2025/0316979 A1
(43) Pub. Date: Oct. 9, 2025

(54) POE PD Redundant System

(71) Applicant: Microchip Technology Incorporated, Chandler, AZ (US)

(72) Inventor: Arkadiy Peker, Glen Cove, NY (US)

(73) Assignee: Microchip Technology Incorporated, Chandler, AZ (US)

(21) Appl. No.: 18/905,830

(22) Filed: Oct. 3, 2024

Related U.S. Application Data
(60) Provisional application No. 63/574,589, filed on Apr. 4, 2024.

(51) Int. Cl. H02J 1/08; H02J 1/10; H02M 1/00; H02M 3/335; H04L 12/10

(52) U.S. Cl. CPC H02J 1/084; H02J 1/106; H02M 1/0067; H02M 3/335; H04L 12/10

(57) ABSTRACT

An apparatus includes interfaces to direct-current-to-direct-current (DC/DC) power converters, the converters to convert power from Ethernet ports to provide power over Ethernet (POE) through POE front-end (FE) circuits to a powered device (PD) consumer device. The apparatus includes a control circuit to cause redundant power to be selectively provided to the PD consumer device from one of the Ethernet ports. The control circuit may determine power characteristics of the POE FE circuits and, based on a power source being inactive and the power characteristics, determine portions from the DC/DC power converters to provide to the PD consumer device.

### PRIORITY

This application claims priority to U.S. Provisional Patent Application No. 63/574,589 filed Apr. 4, 2024, the contents of which are hereby incorporated in their entirety.

### FIELD OF THE INVENTION

The present disclosure relates to power over Ethernet (POE) and, more particularly, to POE power delivery (PD) redundant system for power supply equipment (PSE).

### BACKGROUND

POE may include passing electric power along with data on twisted-pair Ethernet cabling. This may allow a cable to provide both data connection and electric power from a source (referred to as PSE) to devices (referred to as powered devices (PD)). PD devices may include, for example, wireless access points (WAPs), Internet Protocol (IP) cameras, and voice over Internet Protocol (VOIP) phones.

If multiple POE sources such as Ethernet ports are available, as well as other more constant sources such as wall power adapters are available, the power distribution between these sources may need to be divided. Moreover, measurement of the available power from POE sources may be needed, but such measurement often uses opto-couplers for electrical isolation which may be expensive from a space or cost perspective.

Examples of the present disclosure may address one or more of these issues. Examples of the present disclosure may address false POE PSE port shutdowns in case of PSE voltage transients when PSE operate in MPS mode.

### BRIEF DESCRIPTION OF THE DRAWINGS

FIG. 1 illustrates an apparatus for POE redundant PD, according to examples of the present disclosure.

FIG. 2 is a more detailed illustration of an Ethernet port, according to examples of the present disclosure.

FIG. 3 is a more detailed illustration of POE FE circuit, according to examples of the present disclosure.

FIG. 4 is a more detailed illustration of a DC/DC power converter, according to examples of the present disclosure.

FIG. 5 is a more detailed illustration of feedback and control circuitry, according to examples of the present disclosure.

FIG. 6 is an illustration of a method for calculation of voltage, current, power, and energy, according to examples of the present disclosure.

FIG. 7 is an illustration of an example method for setting up a POE PD current limit, according to examples of the present disclosure.

FIG. 8 is an illustration of an example method for setting up current channel ratio, according to examples of the present disclosure.

FIG. 9 is an illustration of an example method for setting up a POE PD class power limit, according to examples of the present disclosure.

### DETAILED DESCRIPTION

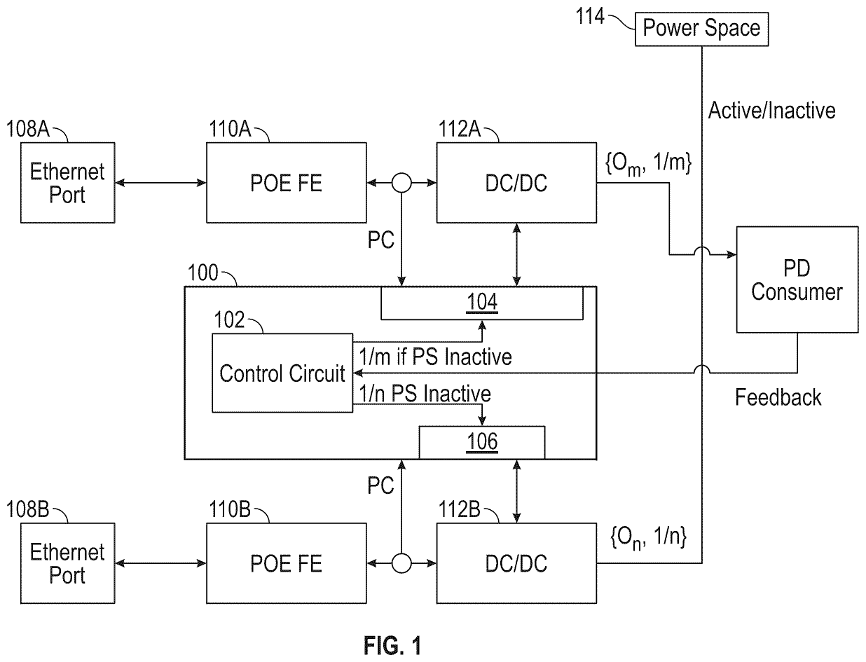

FIG. 1 illustrates an apparatus 100 for POE redundant PD, according to examples of the present disclosure.

Apparatus 100 may include a control circuit 102 and interfaces 104, 106 to DC/DC power converters 112.

Control circuit 102 may be implemented in any suitable manner, such as by analog circuitry, digital circuitry, a field programmable gate array, an application specific integrated circuit, programmable logic, instructions for execution by a processor, a microcontroller, a programmable logic device, or any suitable combination thereof. Interfaces 104, 106 may be implemented in any suitable manner, such as by a wire, bus, pin, lead, or any other suitable electrical connection.

DC/DC power converters 112 may be implemented in any suitable manner, and more detailed examples are discussed further below. Furthermore, various functionality of the present disclosure may be implemented in any suitable location, such as within control circuit 102, apparatus 100, or DC/DC power converters 112.

Interface 104 may connect to a first DC/DC power converter 112A. DC/DC power converter 112A may be configured to convert power from an Ethernet port 108A. Such power may be provided first through a POE front-end (FE) circuit 110A.

POE FE circuits 110 may be implemented in any suitable manner, and are discussed in further detail below. POE FE circuits 110 may be configured to condition or otherwise manipulate the power received from Ethernet port 108 before being converted by DC/DC converter 112.

DC/DC power converter 112A may be configured to provide POE from POE FE circuit 110A to a PD consumer device 116.

Similarly, interface 106 may connect to a second DC/DC power converter 112B. DC/DC power converter 112B may be configured to convert power from an Ethernet port 108B. Such power may be provided first through a POE FE circuit 110B.

DC/DC power converter 112B may be configured to provide POE from POE FE circuit 110B to PD consumer device 116.

PD consumer device 116 may include any suitable device to receive redundant power from Ethernet ports. For example, PD consumer device 116 may include VoIP phones, wireless access points, RFID readers, and IP cameras. Devices that are not general purpose machines, and that serve a networking function and have an Ethernet or other connection, may be popular candidates for implementing PD consumer device 116, although general purpose machines such as computers and servers may still implement PD consumer device 116.

PD consumer device 116 may also be powered, at times or in part, by a constant power source 114. Power source 114 may include, for example, a wall outlet or power adapter.

Power output from DC/DC converters 112 and power source 114 may be connected in parallel to PD consumer device 116. Although shown as a single-edged power connection in FIG. 1, these power connections may be double-edged or differential, wherein both a positive and negative or ground voltage rail may be provided.

Control circuit 102 may be configured to cause redundant power to be selectively provided to PD consumer device 116 from one or more of the first Ethernet port 108A and the second Ethernet port 108B. When power source 114 connected to PD consumer device 116 is inactive, control circuit 102 may be configured to determine a power characteristic of first POE FE circuit 110A and second PEO FE circuit 110B. Such a power characteristic may include voltage, energy, power, or current.

In various examples, the power characteristic of POE FE circuits 110 might not be measured directly, but may be determined through inference in DC/DC converters 112. As discussed in further detail below, such a determination may be made through measurement of the characteristic in DC/DC converters 112 on a secondary side of a secondary set of power converter windings, wherein the primary and secondary sets of power converter windings have an equal number of coils or windings. Such a secondary set of power converter windings may have an effective gain of 1, wherein the voltage on a primary winding and a secondary sensing winding are the same. The secondary set of power converter windings may allow the power characteristic of the primary side (that is, inside of or provided by POE FE circuit 110) to be measured at the secondary side (that is, inside of DC/DC converter 112), thereby electrically isolating the power from Ethernet port 108 from PD consumer 116 but also allowing measurement on the side of Ethernet port 108.

Based upon power source 114 being inactive, and upon the determined power characteristics of POE FE circuits 110, control circuit 102 may be configured to determine a first portion of power from first DC/DC power converter 112A to provide to PD consumer device 116 and a second portion of power from second DC/DC power converter 112B to provide to PD consumer device 116. The first portion of power from first DC/DC power converted 112A may be given as 1/m (of the total power available therein) and the first portion of power from second DC/DC power converted 112B may be given as 1/n. Otherwise, if power source 114 is active, zero power might be provided from DC/DC power converters 112.

Apparatus 100 may provide POE PD redundant operation to PD consumer 116 with cost effective and technically accurate telemetry of POE PD input parameters from POE FE circuit 110 such as current, voltage, power, energy without requiring the use expensive opto-isolators for I2C communication.

Apparatus 100 may conform to POE standards such as IEEE802.3af, IEEE802.3at, IEEE802.3bt, and may be implemented within any suitable system or electronic device

When power source 114 is active, POE FE circuits 110 may issue Maintain Power Signature (MPS) current to Ethernet ports 108 keep such ports active.

The electrical isolation between POE FE circuits 110 and PD consumer 116 may fulfill POE standards, and such electrical isolation may be used for communication, such as according to the I2C standard. Also, in other solutions, a current balancing circuit may otherwise be required on the output of DC/DC converters because without such a circuit, power might not be equal distribution of power between multiple DC/DC converters. For example, one DC/DC converter might provide full power, and yet such full power might not be sufficient for proper load operation at the PD consumer. However, users of the PD consumer may which to limit a given POE current output.

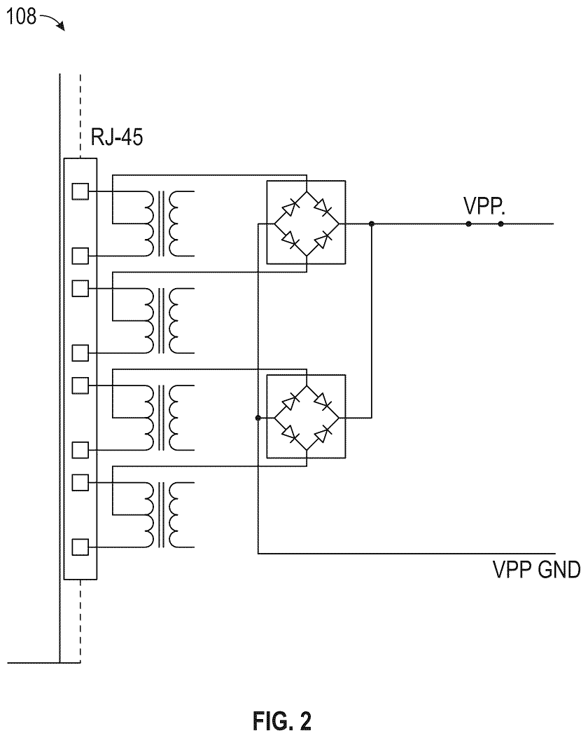

FIG. 2 is a more detailed illustration of an Ethernet port 108, according to examples of the present disclosure.

Ethernet port 108 may include an RJ-45 connector. The connector may include pins that are configured to provide a voltage. The voltage may be tapped at a certain location in a power transformer and rectified. This may be output as VPP. Similarly, a ground voltage value may be accessed through a pin in the RJ-45 connector. The ground voltage may be tapped at another certain location in the power transformer and also rectified. This may be output as GND.

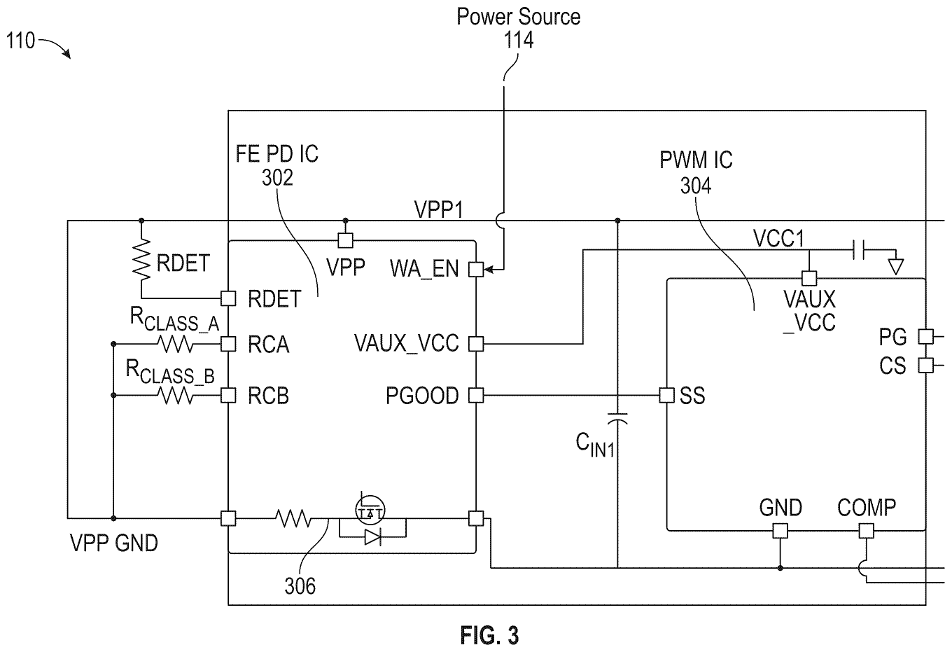

FIG. 3 is a more detailed illustration of POE FE circuit 110, according to examples of the present disclosure.

POE FE circuit 110 may include a FE PD integrated circuit (IC) 302. POE FE circuit 110 may fulfill standards IEEE802.3af, IEEE802.3at and IEEE802.3bt, and may include a detection circuit, a classification circuit for Class A and B, and a switch and circuit to control inrush, short circuit, or overload current. POE FE circuit 110 may include a pulsed-width modulation (PWM) IC 304. Each of ICs 302, 304 may be implemented in any suitable manner, such as by analog circuitry, digital circuitry, a field programmable gate array, an application specific integrated circuit, programmable logic, instructions for execution by a processor, a microcontroller, a programmable logic device, or any suitable combination thereof.

FE PD IC 302 may include ports for RDET, RCA, and RCB. An RDET resistance resistor may be connected between VPP and the port for RDET. RDET may have a resistance of 25 Kohm. During a detection phase, FE PD IC 302 may need to detect such a 25K resistor on the POE PD side of the system. If this resistor is detected, FE PD IC 302 may start a classification phase and then a power up phase. If this resistor is not detected, FE PD IC 302 would not supply power to PD consumer 116. A class A resistor and a class B resistor may be connected respectively to RCA, RCB ports, and to ground. These may include classification resistors Rclass_A and Rclass_B, Classification in POE refers to the process by which a PSE device determines the power requirements of a connected PD power load requirements. The interrogation and power classification function establishes mutual identification and facilitates power management. There may be, for example, eight different classes that can be requested by PD consumer 116. Each such class may have a specific current value. RCA and RCB connected to FE PD IC 302 voltage sources may have resistance values that define the desired classification.

Circuitry 306 may include a switch to control current during inrush and power-on phases.

FE PD IC 302 may have an input VPP for receiving the VPP signal from Ethernet port 106. VPP may serve as a power rail for POE FE circuit 110.

FE PD IC 302 power output may be enabled from an input from power source 114. The input may be logic-low active, wherein if power source 114 fails to send the input, FE PD IC 302 may be configured to output power to DC/DC converter 112.

FE PD IC 302 may be configured to output voltage to PWM IC 304 through VAUX_VCC. VAUX_VCC may provide voltage to start up PWM IC 304 and DC/DC converter 112. After DC/DC converter 112 starts up, voltage for PWM IC 304 and DC/DC converter 112 may be provided by DC/DC converter 112.

FE PD IC 302 may be configured to output a signal to PWM IC 304 through PGOOD. PGOOD may indicate whether an inrush phase is finished and power can be supplied to DC/DC converter 112. PGOOD can be connected to the PWM IC 304 port called soft start circuit (SS). Before DC/DC converter 112 starts up, PGOOD may keep the SS port and the circuit therein low, and when FE PD IC 302 is ready to start, the SS circuit released and DC/DC converter 112 may start up.

PWM IC 304 may output a PG signal and a CS signal to DC/DC converter 112. PG may be a signal to the switching gate of power MOSFET of DC/DC converter 112. And CS may be a current sense signal which comes from DC/DC current sensing circuitry. The PG signal may be a mean power gate output signal. The CS signal may be a mean power current sense signal. The PG signal may be implemented as a sequence of duty-cycle modulated pulses that PWM IC 304 supplies to the gate of a power MOSFET in DC/DC converter 112. The CS signal is a current sense of the source of the power MOSFET in DC/DC converter 112. The CS signal is a supply of voltage to PWM IC 304 and is a replica of the MOSFET current.

PWM IC 304 may receive a COMP signal from DC/DC converter 112. This is a signal to compensation circuitry which provides feedback for DC/DC converter 112.

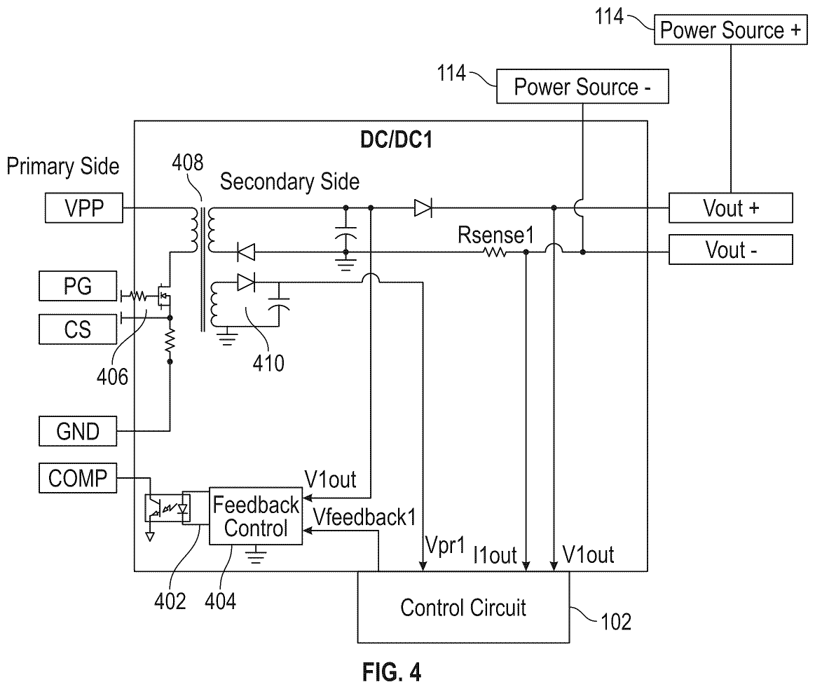

FIG. 4 is a more detailed illustration of a DC/DC power converter 112, according to examples of the present disclosure.

DC/DC power converter 112 may include a first transformer with first transformer windings 408. Input to first transformer windings 408 may be VPP. The ratio of the number of windings on the primary side of transformer windings 408 to the number of windings on the secondary side of transformer windings 408 may dictate the regulated, stepped-up or stepped-down voltage, current, power or electrical energy provided by DC/DC power converter 112, based on VPP. The output of the secondary side of transformer windings 408 may be the output of DC/DC converter 112, shown in differential mode as VOUT+and VOUT−. A capacitor connected between VOUT+and VOUT-may filter the output. The output may be rectified by diodes.

Input of VPP may be switched by PWM IC 304 based upon PG and CS signals as applied to circuitry 406. Circuitry 406 may include a DC/DC switching MOSFET or other suitable switch. Circuitry 406 may also include a current sensing resistor connected to the CS pin.

DC/DC power converter 112 may include a second transformer or a second transformer windings 410 of the first transformer. Second transformer windings 410 may have a same number of windings on its secondary side as on its the primary side-that is, the primary side of transformer windings 408. The number of windings may also be the same as the number of windings as the primary side of first transformer windings 408 if first transformer windings 408 were implemented in a different but parallel transformer.

Since the number of windings of second transformer windings 410 are the same on both of its primary and secondary sides, and since the input to second transformer windings 410 is the same as the input (that is, VPP) to first transformer windings 408, and since the number of windings of second transformer windings 410 (on its primary and secondary sides) are the same as the number of windings on the primary side of first transformer windings 408, an electrical measurement of a power characteristic such as voltage, current, energy, or power of the secondary side of second transformer windings 410 is effectively a determination of the same power characteristic of the primary side of first transformer windings 408. That is, the power characteristic of the output of POE FE circuit 110 (and of Ethernet port 108) may be determined through measurement of the secondary side of second transformer windings 410.

Output of transformer windings 410, representing the determined power characteristic of VPP of a given POE FE circuit 110 and Ethernet port 108, may be routed to control circuit 102 and denoted as VPR. As control circuit 102 may receive one from each set of DC/DC converters 112, these may be denoted respectively as VPR1 and VPR2.

Control circuit 102 may also make measurement or receive feedback from the normal DC/DC operation of DC/DC converter 112, such measuring the power characteristic at the secondary side of primary transformer windings 408. This measurement may be done in any suitable manner. For example, the current (I1out, I2out, respectively of DC/DC converters 112A, 112B) of the output power may be measured as a drop across a known resistor, such as Rsense. Similarly, the voltage (V1out, V2out, respectively of DC/DC converters 112A, 112B) of the output power may be measured from VOUT+.

DC/DC converter 112 may include any suitable components to adjust its output based upon any suitable feedback. For example, DC/DC converter 112 may include a opto-coupler 402 and a DC/DC feedback control circuit 404. Feedback control circuit 404 may accept as inputs VOUT from transformer windings 408 and a VFEEDBACK signal from control circuit 102. Feedback control circuit 404 may be configured to control DC/DC output voltage through opto-coupler 402 through opto-isolation. Opto-coupler 402 may be activated by feedback control circuit 404 when there is a need for decreased voltage output, and thus needing to trigger decreased PWM input. When activated, opto-coupler 402 may be close to ground, signaling COMP on PWM IC 304. Opto-coupler 402 may be deactivated when by feedback control circuit 404 when there is a need for increased voltage output, and thus needing to trigger increased PWM input. When opto-coupler 402 is deactivated, opto-coupler 402 may be further away from ground, signaling COMP on PWM IC 304.

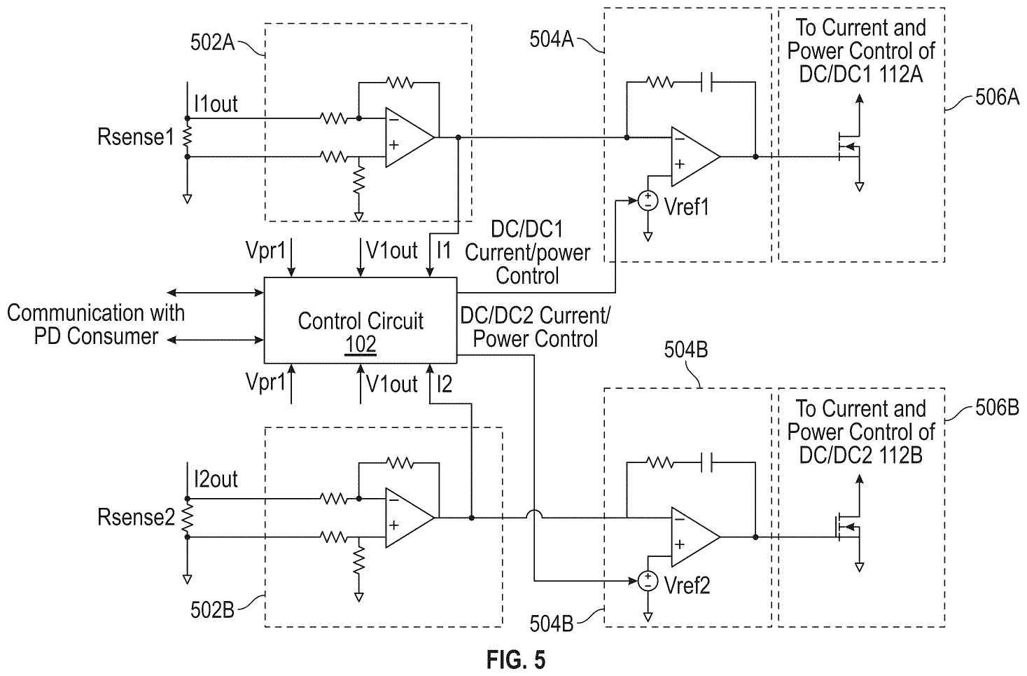

FIG. 5 is a more detailed illustration of feedback and control circuitry, according to examples of the present disclosure.

Circuits 502A, 502B may be current sense amplifier circuits. Circuits 502A, 502B may be configured to sense output current out of DC/DC converter 112. Circuits 502A, 502B may sense such current through a respective output resistor, RSense1 or Rsense2.

Circuits 504A, 504B may be current error amplifiers. Circuits 504A, 504B may compare the current sensed by circuits 502A, 502B against a reference. The reference may be provided by a controllable voltage reference, Vref1 or Vref2, which may be set by control circuit 102.

Circuits 506A, 506B may provide an interface between current control circuits 502, 504 and feedback control 404 circuit of DC/DC converter 112. Output of circuits 506A, 506B may be made as Vfeedback1 and Vfeedback2 as shown in FIG. 4 for DC/DC power converters 112A, 112B, respectively.

Returning to FIG. 1, control circuit 102 may measure current and voltage and calculate power on a secondary side of DC/DC and then using look up table and measured voltage on the primary side to calculate power on the input of PD RJ45 connector.

The power on the input of the RJ-45 of Ethernet port 108 may be given as:

$$Prj 45 = Pdb + Ppd\_ic + Ppd\_pwm + Ppd\_sec / Efficency\_dcdc$$

Where:
Prj45 is power on the input of RJ45, expressed as a function of the current
Pdb is the power dissipation of the diode bridge. This parameter may be specified by a manufacturer, may be measured, or may be measured and stored in a look-up table. Ppd_ic is the power dissipation on FE PD IC 302. This parameter may be specified by a manufacturer, may be measured, or may be measured and stored in a look-up table.
Ppd_pwm is PWM power losses through operation of PWM IC 304. This parameter may be specified by a manufacturer, may be measured, or may be measured and stored in a look-up table.
Pps_sec is the power measured on a secondary side of DC/DC, specifically, the secondary side of transformer windings 408, calculated by IOUT×VOUT
Efficiency _dcdc is the DC/DC efficiency of transformer windings 408. This parameter may be measured in the DC/DC characterization stage.

The voltage on the input of DC/DC converter 112 may be more accurately determined by measuring the output of transformer windings 410. This may be a measurement of the input voltage to DC/DC power converter 112.

Control circuit 102 may measure these telemetry data sources and communicate with PD consumer device 116 without use of opto-isolators such as an I2C opto-isolator. Furthermore, current balancing can be provided based on data received from PD consumer device 116.

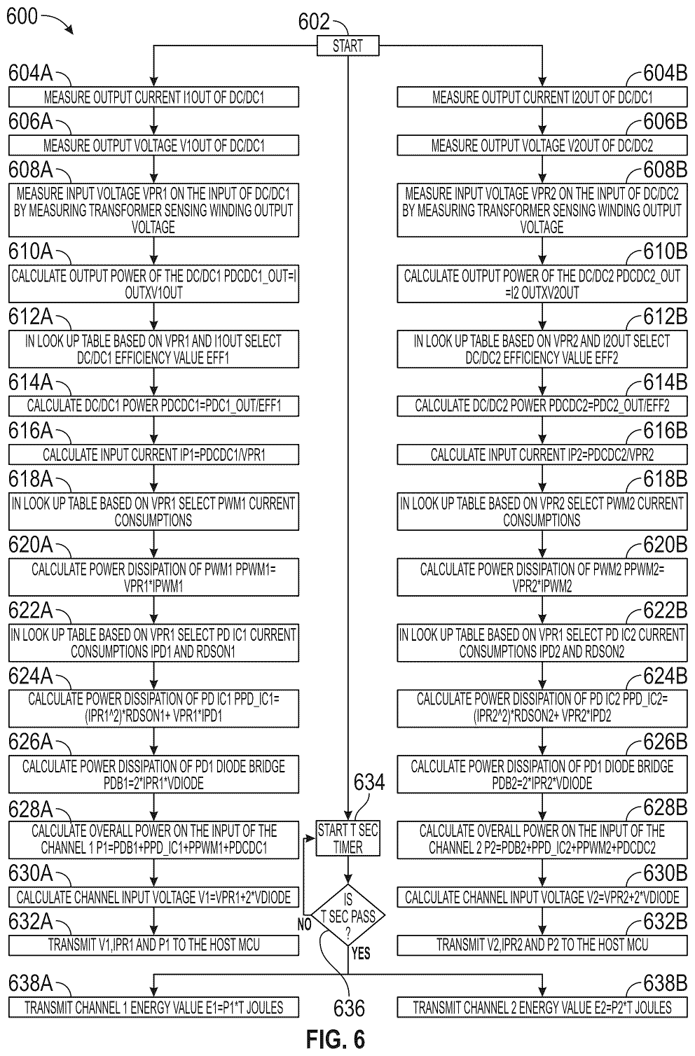

FIG. 6 is an illustration of a method 600 for calculation of voltage, current, power, and energy, according to examples of the present disclosure.

Various steps of method 600 may be repeated for each of DC/DC power converters 112. These may be performed sequentially with respect to one another or in parallel. Equivalent steps for each of DC/DC power converters 112 may be referred to with “A” and “B” designations.

At 602, method 600 may start.

At 604, the output current I1out and I2out may be measured.

At 606, the output voltage V1out and V2out may be measured.

At 608, the input voltage VPR1 and VPR2 to DC/DC power converters 112 may be determined from or taken as the output voltage of the secondary windings of secondary transformer windings 410.

At 610, the theoretical output power of the respective DC/DC power converters 112 may each be given, for a given DC/DC power converter 112X, as PDCDCXOUT=IXOUT*VXOUT.

At 612, for a given DC/DC power converter 112X, VPRX and IXOUT may be used to access a look-up table to determine efficiency of DC/DC power converter 112X, given as EFFX.

At 614, for a given DC/DC power converter 112X, the effective input power may be given as PDCDCX=PDCDCXOUT/EFFX.

At 616, for a given DC/DC power converter 112X, input current may be calculated as IPRX=PDCDCX/VPRX.

At 618, for a given POE FE circuit 110X, VPRX may be used in a look-up table to determine current consumptions (IPWMX) for PWM IC 304X.

At 620, for a given POE FE circuit 110X, the power dissipation for PWM IC 304X may be calculated as PPWMX=VPRX*IPWMX.

At 622, for a given POE FE circuit 110X, VPRX may be used in a look-up table to determine the current consumption IPDX and RDSONX value for FE PD IC 302X. In the parlance of FIG. 3, IPDX may be the current from the input of VPP, and RDSONX may be the RDSON value of the switch of MOSFET 306.

At 624, the power dissipation of FE PD IC 302X may be calculated as PPD-ICX=(IPRX\hat{ }2)*RDSONX+VPRX*IPDX.

At 626, the power dissipation of a given PDX diode bridge may be calculated as PDBX=2*IPRX*VDIODE. VDIODE may be the voltage drop of a single diode in the bridge illustrated in FIG. 2. This parameter may be specified in a data sheet.

At 628, the overall input power of the channel, the channel including all elements connecting between PD consumer 116 and a given Ethernet port 108, X may be calculated as

$$PX = PDBX + PPD - ICX + PPWMX + PDCDCX .$$

At 630, the channel input voltage provided by a given RJ45 connector for the given channel X may be given as VX=VPRX+2*VDIODE.

At 632, the VX, IPRX, and PX may be transmitted to PD consumer device 116 as reported telemetry data.

At 634, after 602 and in parallel with 604-632, a timer for t seconds may be started.

At 636, if t seconds have elapsed, then at 638 channel X energy value of EX=P2*t joules may be transmitted to consumer PD device 116.

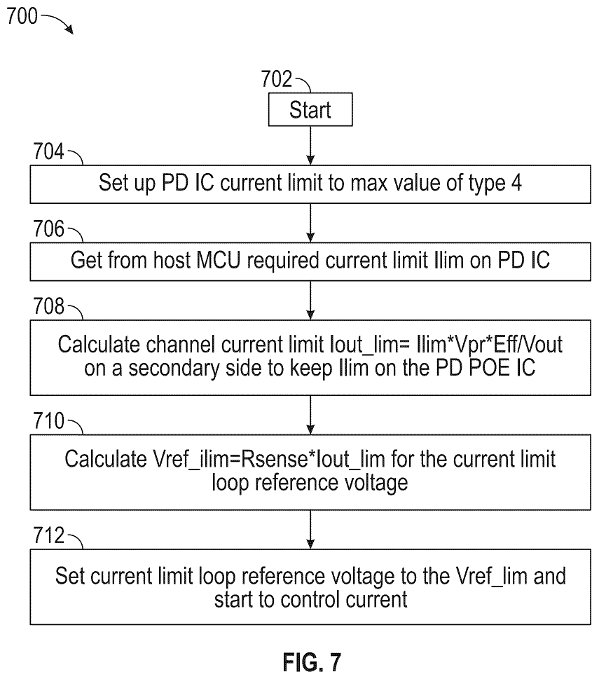

FIG. 7 is an illustration of an example method 700 for setting up a POE PD current limit.

At 702, method 700 may begin.

At 704, a given FE PD IC 302X may be set up with a current limit to a maximum value of type 4, or another suitable maximum power PD type.

At 706, a required current limit may be obtained from a host MCU such as PD consumer device 116. This may be given as LIMX.

At 708, a channel current limit, calculated as IOUT-LIMX=ILIMX*VPRX*EFF/VOUTX (such as V1OUT or V2OUT). This may be used on a secondary side to maintain ILIMX on the FE PD IC 302X. Eff is an efficiency of the DC/DC. This value is determined by characterization and usually in a range of 0.87 to 0.95.

At 710, a voltage reference limit, given as VREF-ILIMX, for use as the VREF in element 504, may be determined as RSENSEX*IOUT-LIMX. This is a maximum value that VREF may be set to.

At 712, the value of VREF may be to VREF-ILIMX.

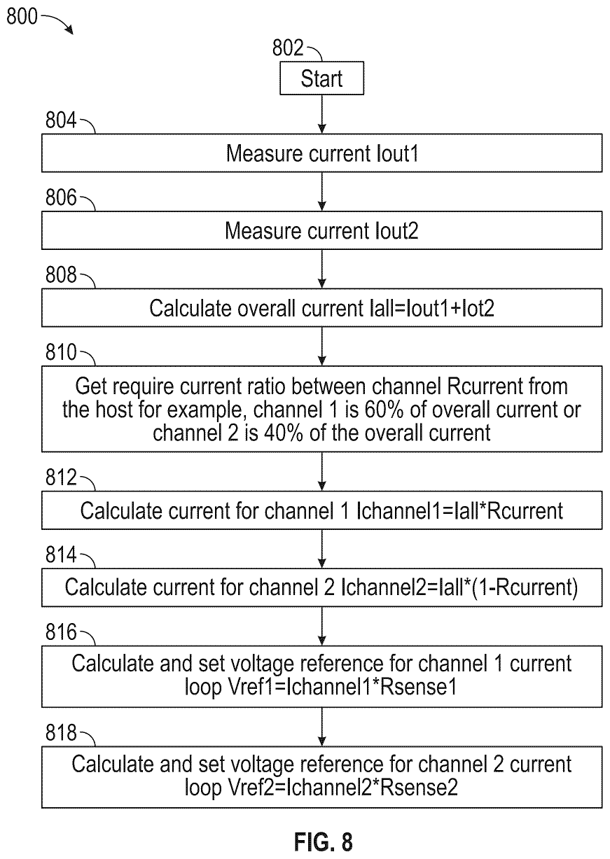

FIG. 8 is an illustration of an example method for setting up current channel ratio.

At 802, method 800 may begin.

At 804, IOUT1 as the current load may be measured. At 806, IOUT2 may be measured.

At 808, the overall current may be determined as the sum of IOUT1 and IOUT2.

At 810, the ratio of currents to be provided by DC/DC converters 112 may be determined from a host such as PD consumer device 116. This may be specified by a percentage of the current to come from one converter versus the other converter,

At 812, desired current for channel 1 may be calculated as overall current*Rcurrent.

At 814, desired current channel 2 may be calculated as overall current*(1−Rcurrent).

At 816, a reference voltage value to achieve the desired current for channel 1 may be calculated and set, wherein VREF1=overall current*Rcurrent*Rsense1.

At 818, a reference voltage value to achieve the desired current for channel 2 may be calculated and set, wherein VREF2=overall current*(1−Rcurrent)*Rsense2.

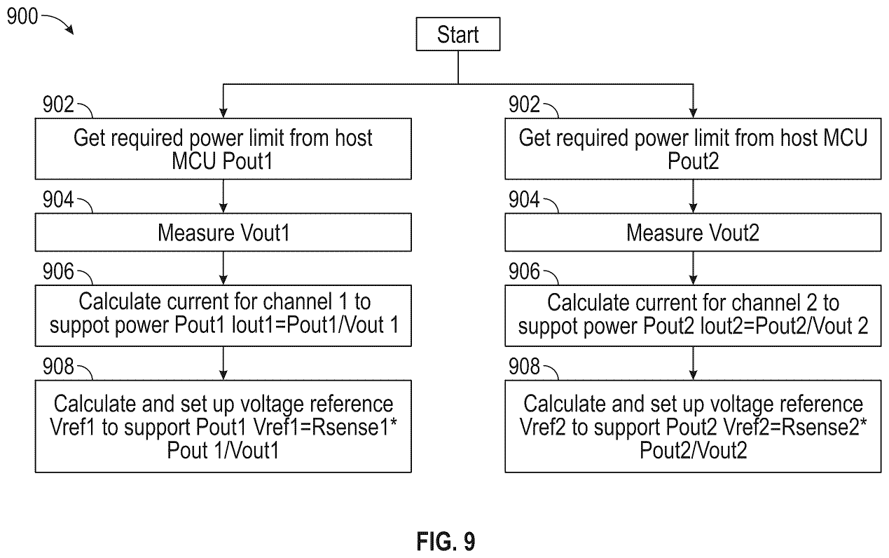

FIG. 9 is an illustration of an example method 900 for setting up a POE PD class power limit.

At 902, a required power limit may be obtained from a host MCU such as PD consumer device 116. This may be given as POUT.

At 904, VOUT may be measured.

At 906, the current needed for the DC/DC power converter to support the required POUT may be calculated as IOUT=POUT/VOUT.

At 908, a value for reference voltage VREF may be calculated and applied, in order to support the required POUT, given as VREF=RSENSE*POUT/VOUT.

Examples of the present disclosure may include an apparatus. The apparatus may include a first interface to a first DC/DC power converter. The first DC/DC power converter may be to convert power from a first Ethernet port to provide POE through a first POE FE circuit to a PD consumer device. The apparatus may include a second interface to a second DC/DC power converter. The second DC/DC power converter may be to convert power from a second Ethernet port to provide POE through a second POE FE circuit to the PD consumer device. The interfaces may be implemented in any suitable manner, such as by a pin or bus. The apparatus may include a control circuit. The control circuit may be implemented in any suitable manner, such as by analog circuitry, digital circuitry, a field programmable gate array, an application specific integrated circuit, programmable logic, instructions for execution by a processor, a microcontroller, a programmable logic device, or any suitable combination thereof. The control circuit may be to cause redundant power to be selectively provided to the PD consumer device from one or more of the first Ethernet port and the second Ethernet port. The control circuit may be to determine when a power source is connected to the PD consumer device is inactive, and, if so, determine a power characteristic of the first POE FE circuit and the second PEO FE circuit. The control circuit may be to, based on the power source being inactive and the first power characteristic of the first POE FE circuit and the second POE FE circuit, determine a first portion of power from the first DC/DC power converter to provide to the PD consumer device and a second portion of power from the second DC/DC power converter to provide to the PD consumer device.

In combination with any of the above examples, the control circuit may be to, when the power source is active, cause power to the PD consumer device from the first DC/DC power converter and the second DC/DC power converter to be disconnected.

In combination with any of the above examples, the first DC/DC power converter and the second DC/DC power converter may be to electrically isolate the PD consumer device from the first POE FE circuit and the second POE FE circuit.

In combination with any of the above examples, the control circuit may be to cause measurement of the power characteristic of a secondary side of the first DC/DC power converter and of a secondary side of the second DC/DC power converter, and cause determination of the power characteristic of a primary side of the first DC/DC power converter and of a primary side of the second DC/DC power converter.

In combination with any of the above examples, the determination of the power characteristic of the primary side of the first DC/DC power converter and of the primary side of the second DC/DC power converter may be made on the respective secondary sides of the first and second DC/DC power converters at a secondary winding on the respective secondary sides of the first and second DC/DC power converters, the secondary winding on the respective secondary sides of the first and second DC/DC power converters and to have a same winding count as respective primary windings on the respective primary sides of the first and second DC/DC power converters. The secondary windings on the secondary sides may be on a same transformer as the primary windings or on another transformer compared to the primary windings.

In combination with any of the above examples, the control circuit may be to estimate power consumption of the respective first and second POE FE circuits based upon the determination of the power characteristic of the respective primary sides of the first and second power converters and measurement of the power characteristic at the respective secondary sides of the second power converters at the respective secondary windings on the respective secondary sides of the first and second DC/DC power converters.

In combination with any of the above examples, the control circuit is to communicate with the PD consumer device and determine power needs of the PD consumer device. The power source, the first DC/DC power converter, and the second DC/DC power converter may be connected to provide power to the PD consumer device in parallel. The control circuit may be to selectively enable a combination of the first DC/DC power converter and the second DC/DC power converter to power the PD consumer device.

Examples of the present disclosure may include a system. The system may include any of the apparatuses of the above examples. The system may include the DC/DC power converters. The system may be implemented within, for example, a microcontroller.

Examples of the present disclosure may include a method. The method may include operations of any of the above example apparatuses or systems.

Although examples have been described above, other variations and examples may be made from this disclosure without departing from the spirit and scope of these examples.

We claim:

1. An apparatus, comprising:
a first interface to a first direct-current-to-direct-current (DC/DC) power converter, the first DC/DC power converter to convert power from a first Ethernet port to provide power over Ethernet (POE) through a first POE front-end (FE) circuit to a powered device (PD) consumer device;
a second interface to a second direct-current-to-direct-current (DC/DC) power converter, the second DC/DC power converter to convert power from a second Ethernet port to provide POE through a second POE FE circuit to the PD consumer device; and
a control circuit to:
cause redundant power to be selectively provided to the PD consumer device from one or more of the first Ethernet port and the second Ethernet port;
when a power source connected to the PD consumer device is inactive:
determine a power characteristic of the first POE FE circuit and
the second PEO FE circuit; and
based on the power source being inactive and the first power characteristic of the first POE FE circuit and the second POE FE circuit, determine a first portion of power from the first DC/DC power converter to provide to the PD consumer device and a second portion of power from the second DC/DC power converter to provide to the PD consumer device.

2. The apparatus of claim 1, wherein the control circuit is to, when the power source is active, cause power to the PD consumer device from the first DC/DC power converter and the second DC/DC power converter to be disconnected.

3. The apparatus of claim 1, wherein the first DC/DC power converter and the second DC/DC power converter are to electrically isolate the PD consumer device from the first POE FE circuit and the second POE FE circuit.

4. The apparatus of claim 1, wherein the control circuit is to:
cause measurement of the power characteristic of a secondary side of the first DC/DC power converter and of a secondary side of the second DC/DC power converter; and
cause determination of the power characteristic of a primary side of the first DC/DC power converter and of a primary side of the second DC/DC power converter.

5. The apparatus of claim 4, wherein the determination of the power characteristic of the primary side of the first DC/DC power converter and of the primary side of the second DC/DC power converter is to be made on the respective secondary sides of the first and second DC/DC power converters at a secondary winding on the respective secondary sides of the first and second DC/DC power converters, the secondary winding on the respective secondary sides of the first and second DC/DC power converters and to have a same winding count as respective primary windings on the respective primary sides of the first and second DC/DC power converters.

6. The apparatus of claim 5, wherein the control circuit is to estimate power consumption of the respective first and second POE FE circuits based upon the determination of the power characteristic of the respective primary sides of the first and second power converters and measurement of the power characteristic at the respective secondary sides of the second power converters at the respective secondary windings on the respective secondary sides of the first and second DC/DC power converters.

7. The apparatus of claim 1, wherein:
the control circuit is to communicate with the PD consumer device and determine power needs of the PD consumer device;
the power source, the first DC/DC power converter, and the second DC/DC power converter are connected to provide power to the PD consumer device in parallel; and
the control circuit is to selectively enable a combination of the first DC/DC power converter and the second DC/DC power converter to power the PD consumer device.

8. A system, comprising:
a first direct-current-to-direct-current (DC/DC) power converter, the first DC/DC power converter to convert power from a first Ethernet port to provide power over Ethernet (POE) through a first POE front-end (FE) circuit to a powered device (PD) consumer device;
a second direct-current-to-direct-current (DC/DC) power converter, the second DC/DC power converter to convert power from a second Ethernet port to provide POE through a second POE FE circuit to a PD (PD) consumer device;
and
a control circuit to:
cause redundant power to be selectively provided to the PD consumer device from one or more of the first Ethernet port, and the second Ethernet port;
when a power source connected to the PD consumer device is inactive:
determine a power characteristic of the first POE FE circuit and the
second POE FE circuit; and
based on the power source being inactive and the first power characteristic of the first POE FE circuit and the second POE FE circuit, determine a first portion of power from the first DC/DC power converter to provide to the PD consumer device and a second portion of power from the second DC/DC power converter to provide to the PD consumer device.

9. The system of claim 8, wherein the control circuit is to, when the power source is active, cause power to the PD consumer device from the first DC/DC power converter and the second DC/DC power converter to be disconnected.

10. The system of claim 8, wherein the first DC/DC power converter and the second DC/DC power converter are to electrically isolate the PD consumer device from the first POE FE circuit and the second POE FE circuit.

11. The system of claim 8, wherein the control circuit is to:
cause measurement of the power characteristic of a secondary side of the first DC/DC power converter and of a secondary side of the second DC/DC power converter; and
cause determination of a primary side of the first DC/DC power converter and of a primary side of the second DC/DC power converter.

12. The system of claim 11, wherein:
the first DC/DC power converter includes:
a primary winding on a primary side of the first DC/DC power converter to receive power from the first POE FE circuit;
a first secondary winding on a secondary side of the first DC/DC power converter to provide power to the PD consumer device, wherein a ratio of windings between the primary winding and the first secondary winding is to provide a power step-up or step-down between power received from the first POE FE circuit and power to be provided to the PD consumer device; and
a second secondary winding on the secondary side of the first DC/DC power converter, wherein the second secondary winding and the primary winding have a same number of windings;
the second DC/DC power converter includes:
a primary winding on a primary side of the second DC/DC power converter to receive power from the second POE FE circuit;
a first secondary winding on a secondary side of the second DC/DC power converter to provide power to the PD consumer device, wherein a ratio of windings between the primary winding and the first secondary winding is to provide a power step-up or step-down between power received from the second POE FE circuit and power to be provided to the PD consumer device; and
a second secondary winding on the secondary side of the second DC/DC power converter, wherein the second secondary winding and the primary winding have a same number of windings;
the measurement circuit is to cause determination of the power characteristic of the primary side of the first DC/DC power converter and of the primary side of the second DC/DC power converter at the respective secondary windings of the first and second DC/DC power converters.

13. The system of claim 12, wherein the control circuit is to estimate power consumption of the respective first and second POE FE circuits based upon the determination of the power characteristic of the respective primary sides of the first and second power converters at the respective secondary windings on the respective secondary sides of the first and second DC/DC power converters.

14. The system of claim 8, wherein:
the control circuit is to communicate with the PD consumer device and determine power needs of the PD consumer device;
the power source, the first DC/DC power converter, and the second DC/DC power converter are connected to provide power to the PD consumer device in parallel; and
the control circuit is to selectively enable a combination of the first DC/DC power converter and the second DC/DC power converter to power the PD consumer device.

15. A method, comprising:
with a first direct-current-to-direct-current (DC/DC) power converter, converting power from a first Ethernet port to provide power over Ethernet (POE) to a consumer powered device (PD);
with a second direct-current-to-direct-current (DC/DC) power converter, converting power from a second Ethernet port to provide POE to the consumer PD;
causing redundant power to be provided to the PD consumer device from the first Ethernet port and the second Ethernet port;
and
when a power source is inactive:
determining a power characteristic of the first POE FE circuit and the second POE FE circuit; and
based on the power source being inactive and the first power characteristic of the first POE FE circuit and the second POE FE circuit, determining a first portion of power from the first DC/DC power converter to provide to the PD consumer device and a second portion of power from the second DC/DC power converter to provide to the PD consumer device.

16. The method of claim 15, comprising, when the power source is active, disconnecting power to the PD consumer device from the first DC/DC power converter and the second DC/DC power converter.

17. The method of claim 15, comprising using the first DC/DC power converter and the second DC/DC power converter to electrically isolate the PD consumer device from the first POE FE circuit and the second POE FE circuit.

18. The method of claim 15, comprising:
measuring the power characteristic of a secondary side of the first DC/DC power converter and of a secondary side of the second DC/DC power converter; and
determining the power characteristic of a primary side of the first DC/DC power converter and of a primary side of the second.

19. The method of claim 18, wherein:
the first DC/DC power converter includes:
a primary winding on a primary side of the first DC/DC power converter to receive power from the first POE FE circuit;
a first secondary winding on a secondary side of the first DC/DC power converter to provide power to the PD consumer device, wherein a ratio of windings between the primary winding and the first secondary winding is to provide a power step-up or step-down between power received from the first POE FE circuit and power to be provided to the PD consumer device; and
a second secondary winding on the secondary side of the first DC/DC power converter, wherein the second secondary winding and the primary winding have a same number of windings;
the second DC/DC power converter includes:
a primary winding on a primary side of the second DC/DC power converter to receive power from the second POE FE circuit;
a first secondary winding on a secondary side of the second DC/DC power converter to provide power to the PD consumer device, wherein a ratio of windings between the primary winding and the first secondary winding is to provide a power step-up or step-down between power received from the second POE FE circuit and power to be provided to the PD consumer device; and
a second secondary winding on the secondary side of the second DC/DC power converter, wherein the second secondary winding and the primary winding have a same number of windings;
wherein the method includes determining the power characteristic of the primary side of the first DC/DC power converter and of the primary side of the second DC/DC power converter at the respective secondary windings of the first and second DC/DC power converters.

20. The method of claim 19, comprising estimating power consumption of the respective first and second POE FE circuits based upon the determination of the power characteristic of the respective primary sides of the first and second power converters at the respective secondary windings on the respective secondary sides of the first and second DC/DC power converters.
